(19) United States
(12) Patent Application Publication
(10) Pub. No.: US 2026/0258278 A1
(43) Pub. Date: Sep. 3, 2026

(54) PROCESS FOR WET ON WET APPLICATION OF A MULTILAYER COATING

(71) Applicant: AXALTA COATING SYSTEMS IP CO., LLC, Wilmington, DE (US)

(72) Inventors: Klaus Wissing, Haan (DE); Andrew Duda, Gladbeck (DE)

(73) Assignee: AXALTA COATING SYSTEMS IP CO., LLC, Wilmington, DE (US)

(21) Appl. No.: 19/405,035

(22) Filed: Dec. 1, 2025

Related U.S. Application Data
(63) Continuation of application No. 15/970,259, filed on May 3, 2018, now abandoned.
(60) Provisional application No. 62/504,654, filed on May 11, 2017.

(30) Foreign Application Priority Data
May 3, 2018 (DE) 10 2018 110 594.0

(51) Int. Cl. C09D 177/04; B05D 7/00; B05D 7/14; B32B 15/088; C08G 18/38; C08G 18/60; C08G 18/72; C08G 18/79; C08K 3/013; C08K 3/08; C08K 3/16; C08K 3/22; C08K 5/17; C08L 75/04; C09D 17/00; C09D 175/04

(52) U.S. Cl. CPC C09D 177/04; B05D 7/532; B32B 15/088; C08G 18/3821; C08G 18/603; C08G 18/722; C08G 18/792; C08K 3/08; C08K 3/16; C08K 5/17; C09D 175/04; B05D 7/14; B05D 7/56; B05D 7/572; B05D 2202/00; B05D 2350/10; B05D 2451/00; B32B 2255/06; B32B 2605/00; C08K 2003/0881; C08K 2003/2241; C08L 75/04; C08L 2312/00; C09D 17/003; C09D 17/005; C09D 17/007

(57) ABSTRACT

A wet on wet process for multilayer coating of a substrate includes applying on the substrate to be coated a surfacer layer of an organic solvent-based surfacer coating composition comprising at least one polyaspartic acid ester, at least one polyisocyanate cross-linking agent with free isocyanate groups, at least one pigment and/or extender and at least one organic solvent. The surfacer layer on coated substrate is flashed off and a top coat layer is applied on the surfacer layer.

### CROSS-REFERENCE TO RELATED APPLICATIONS

This application is a continuation of U.S. application Ser. No. 15/970,259, filed May 3, 2018, which claims the benefit of U.S. Provisional Application No. 62/504,654, filed May 11, 2017, and further claims priority to German Application No. 10 2018 110 594.0, filed May 3, 2018.

### TECHNICAL FIELD

The present invention relates to a wet on wet process for multilayer coating of a substrate, which may particularly be used for coating and repair coating vehicle bodies and vehicle body parts.

### BACKGROUND

Multilayer coatings made up, for example, of a primer layer, a surfacer layer, and a top coat layer, the top coat layer for example comprising a base coat and a clear coat or being a pigmented single stage top coat layer, are typical coating structures in vehicle coating and vehicle repair coating. The different layers of a multilayer coating are applied one after each other. Between each application step a certain drying time is required until the next layer may be applied. The actually required minimum drying time until a previously applied coating can be overcoated depends on various factors, such as for instance physical drying and reactivity of the applied coating composition, the amount and nature of the solvent contained in the coating composition, the presence of curing catalysts as well as external factors such as drying temperature and humidity during drying. In any case, before applying a further coating layer on a previously applied coating layer, it is necessary that, on the one hand, the previously applied coating layer has sufficiently dried so that for instance it does not mix or react with the further coating layer and mechanical resistance is sufficient. On the other hand, in particular for surfacer layers, it is also desirable that after drying the mechanical resistance is such that it is still possible to de-nib imperfections in the dried layer before any further layer such as a basecoat or a pigmented single stage top coat layer is applied. Imperfections of the surfacer layer may also be visible after application of a further layer and, hence, deteriorate the optical appearance of the final coating. In other words, all the above requirements influence the overall quality and in particular the optical appearance of any top coat layer which is coated on the previously applied surfacer layer.

Moreover, productivity is an important issue in vehicle coating and vehicle repair coating. In particular, in case a multilayer coating is applied, drying times of each of the multiple coating layers should be as short as possible in order to shorten the overall time which is needed to complete the coating process. Usually, as long as the coating process has not been completed, the vehicle has to stay within the spray facilities such as a spray booth. Consequently, the longer one vehicle occupies in average the spray facilities, the less vehicles can be processed within a given time period.

A currently frequently used processes for applying multilayer coatings in particular in the field of vehicle repair coating (refinishing) are sanding processes. In a sanding process, after application and at least partial drying of the first layer, such as for instance a surfacer layer, the first layer is surface treated by sanding. Such abrasive surface treatment for instance allows for levelling out of unevenness of the coated surface but may also be useful to enhance intercoat adhesion to subsequently applied coating layers. However, the application of a sanding process, firstly, requires a more or less completely dried and/or cured coating layer and, secondly, creates sand dust which has to be removed from the sanded surface in an additional cleaning step which both is time consuming as well as economically and environmentally undesirable. A wet on wet application process as also used for the application of multilayer coatings for instance in refinishing applications does not suffer from these procedural draw backs since in a wet on wet application process no sanding of the first applied layer, such as for instance a surfacer layer, is performed. However, currently used coating compositions tend to require a considerable long drying time (“flashing off time”) and/or also the optical appearance of the final coating is not always satisfactory.

Currently used coating compositions for surfacers and top coats for wet on wet applications are for instance special wet on wet two-component polyurethane compositions which are formulated mainly with acrylic and/or polyester resins. Such surfacer compositions are frequently reduced in pigment volume concentration and are adjusted to lower spray viscosities to obtain an even and smooth flow after application. The compositions may also use a favorable extender composition to obtain a good appearance after topcoat application. As reactivity is limited for OH/NCO cured compositions longer air drying times of e.g. 15-30 minutes are needed before de-nibbing of imperfections can be performed and good and defect free final top coat appearance can be obtained. In addition, surface defects such as eruptions can occur, for instance when waterborne basecoats are applied too early to the previously applied surfacer layer.

An alternative current approach is to use modified two-component polyurethane sanding surfacers. In principle, the modified surfacer is based on a sanding surfacer which is converted into a wet on wet surfacer for instance by adding a binder solution and/or reducing the pigment volume concentration so to increase the spray performance and surface leveling. However, these surfacers do not meet the highest level of top coat appearance of a subsequently applied top coat layer and do also not have a high productivity.

It is further known in the art that the drying performance of standard two-component polyurethane wet on wet surfacers can be accelerated by using high levels of curing catalysts such as for instance dibutyl tin dilaureate (DBTL). Such approach can lead to shorter air dry times which makes it possible to perform de-nibbing and overcoating already after short drying times. However, the final top coat appearance of a subsequently applied top coat layer is deteriorated and potlife is shortened.

Thus, an object of the present invention is to provide a process for wet on wet multilayer coating of a surfacer layer and a top coat layer on a substrate which can be used in vehicle coating such as OEM processes as well as in vehicle repair coating (refinishing) and which provides high productivity while still providing the possibility for de-nibbing imperfections in the surfacer layer before the application of the top coat layer and, at the same time, maintaining or even exceeding the final top coat appearance, in particular after finishing with a clearcoat layer and curing, as well as maintaining or even exceeding adhesion and corrosion protection properties of conventional surfacer compositions. It is a particular further object of the present invention to provide a method in which also water-based top coat compositions, such as for instance a water-based base coat, can be applied to the surfacer layer. These objects are solved by the process as defined in the claims and described in the following description.

### SUMMARY OF THE INVENTION

The present invention relates to a wet on wet process for multilayer coating of a substrate, in particular for multilayer repair coating of a substrate, the process comprising the steps of:
(i) applying on the substrate to be coated a surfacer layer of an organic solvent-based surfacer coating composition comprising:
   A) at least one polyaspartic acid ester;
   B) at least one polyisocyanate cross-linking agent with free isocyanate groups;
   C) at least one pigment and/or extender; and
   D) at least one organic solvent;
(ii) flashing off the surfacer layer; and
(iii) applying a top coat layer on the surfacer layer.

The present invention is further directed to the use of a coating composition comprising:
A) at least one polyaspartic acid ester;
B) at least one polyisocyanate cross-linking agent with free isocyanate groups;
C) at least one pigment and/or extender; and
D) at least one organic solvent
   as a surfacer in a wet on wet process for multilayer coating of a substrate, in particular for multilayer repair coating of a substrate.

Surprisingly, it has been found that the disadvantages of the prior art solutions can be overcome when performing the above-described process. A substantially enhanced productivity under air drying compositions—without the need to apply heat—has been achieved without impairing de-nibbing capabilities of the surfacer as well as top coat appearance of a top coat layer which is subsequently applied on the surfacer layer. In particular, it has been found that in case a surfacer layer containing a polyaspartate acid ester, a polyisocyanate cross-linking agent with free isocyanate groups, at least one pigment and/or extender and at least one organic solvent is used as a surfacer, it is possible to combine a high productivity with very good de-nibbing capabilities of the surfacer layer and very good top coat appearance of a top coat layer which is applied on the surfacer layer.

### DETAILED DESCRIPTION OF THE INVENTION

The invention will be explained in more detail below.

It will be appreciated that certain features which are, for clarity, described above and below in the context of separate embodiments may also be provided in combination in a single embodiment. Conversely, various features that are, for brevity, described in the context of a single embodiment may also be provided separately or in any sub-combination. In addition, references in the singular may also include the plural (for example, “a” and “an” may refer to one, or one or more) unless the context specifically states otherwise.

A wet on wet application process as described herein is specified in that after application of a first layer, i.e. the surfacer layer, and subsequent flashing off the surfacer layer, the surfacer layer is not sanded and in particular not sanded over the whole applied area for instance with the objective to smooth the surface of the surfacer layer by removing any undesired structure therefrom. In other words, a wet on wet application process is not a sanding process. Moreover, the duration as well as the conditions of the flashing off of the surfacer before the application of a top coat layer such as for instance temperature, air circulation or humidity shall be understood not to be limited by the term wet on wet application process.

A sanding process removes paint material and creates sand dust which has to be removed from the sanded surface in an additional cleaning step. Moreover, the paint removed by sanding is typically measurable in μm film thickness and can be considerable. Nearly up to the whole film build can be sanded away, in particular, if there is an unevenness of the substrate which shall be levelled out by the surfacer. The levelling out of an unevenness of the substrate and/or removal of the structure of the applied surfacer by sanding is characteristic for a sanding process but is not possible in a wet on wet or a non-sanding process. The latter process is therefore defined by the absence of the possibility to remove structure and to level out unevenness of the substrate. In other words, in the context of the present invention, a wet on wet application process and a non-sanding process shall be understood as being the same.

De-nibbing is a carefully and mainly manually performed activity using a soft pad which is applied with only very low pressure on the at least partially dried coating. In the present invention, de-nibbing is an optional step of the wet on wet application process wherein only local and usually very small areas of the coating are treated. The aim of de-nibbing is to remove small surface imperfections of the surfacer layer prior to the application of a further top coat layer since such imperfection may still be seen after top coat application. These surface imperfections are usually caused by contaminations such as for instance foreign dust. In view of the locally limited application, the different objective as well as the more careful performing of the de-nibbing, it will be appreciated that de-nibbing and sanding are completely different process steps. In addition, in contrast to a whole area sanding of a surfacer, de-nibbing is not capable to enhance intercoat adhesion to subsequently applied coating layers.

The term (meth)acrylic as used herein and hereinafter should be taken to mean methacrylic and/or acrylic.

Unless stated otherwise, all molecular weights (both number and weight average molecular weight) referred to herein are determined by GPC (gel permeation chromatography) using polystyrene as the standard and tetrahydrofurane as the liquid phase eluent.

Water-based or aqueous coating compositions are coating compositions wherein water is used as solvent or thinner when preparing and/or applying the coating composition. Usually, water-based coating compositions may contain, for example, about 30 to about 90% by weight of water, based on the total amount of the coating composition and optionally, up to about 30% by weight, preferably, below about 15% by weight of organic solvents, based on the total amount of the coating composition.

Organic solvent-based coating compositions are coating compositions wherein organic solvents are used as solvents or thinners when preparing and/or applying the coating composition. Usually, solvent-based coating compositions contain, for example, about 20 to about 90% by weight of organic solvents, based on the total amount of the coating composition.

Surfacers are defined as filled coating compositions forming the contact to the top coat layer. They create adhesion to the top coat, contribute to corrosion protection, fill in unevennesses and prevent “sinkage” of the top coat and marking of substrate surface differences. Surfacers are applied in coating layers of, e.g., about 20 to about 400 μm (see, for example, definition in “Vehicle Refinishing”, Fritz Sadowski).

The individual steps of the process contemplated herein are explained in more detail below.

Substrates which may be coated with a multilayer coating in the wet on wet process of the present invention in principle may be any substrate such as e.g. metal, plastic, putty, e-coated metal (E-coat), steel or any of these substrates with an existing coating such as aged coating (old paintwork), and preferably is E-coat, metal or old paintwork. Suitable metal substrates are e.g. the metal substrates known in the automotive industry, such as for example iron, zinc, aluminium, magnesium, stainless steel or the alloys thereof. Preferably, the substrates are vehicle bodies and vehicle body parts. Thus, for example, the substrate may be a metal substrate which preferably comprises vehicle bodies or vehicle body parts.

In step (i) of the process contemplated herein, on the substrate to be coated or repair coated a surfacer layer of an organic solvent based surfacer coating composition is applied. The surfacer coating composition comprises A) at least one polyaspartic acid ester, B) at least one polyisocyanate cross-linking agent with free isocyanate groups, C) at least one pigment and/or an extender, and D) at least one organic solvent.

The surfacer coating composition is a two-component coating composition, i.e. the components that are reactive towards one another, namely the polyaspartic acid ester (A) and the polyisocyanate cross-linking agent (B), are be stored separately from one another prior to application in order to avoid a premature reaction. Generally, component (A) and polyisocyanate component (B) may only be mixed together shortly before application. The term “shortly before application” is well-known to a person skilled in the art. The time period within which the ready-to-use coating composition may be prepared prior to the actual use/application depends, e.g., on the pot life of the coating composition. Compositions with very short potlife may be applied by two-component spray guns, where the reactive components are separately fed into a static mixer and applied directly afterwards.

### Component A) of the Surfacer Coating Composition

The polyaspartic acid ester A) may be a compound of Formula (I) and preferably is a compound of Formula (I):

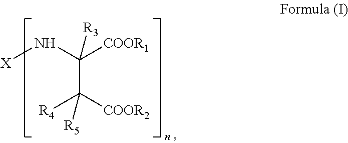

wherein X represents an n-valent organic group, preferably a divalent hydrocarbon group, obtained by removal of the amino groups from a primary polyamine or polyetheramine; R1 and R2 are the same or different organic groups which are inert towards isocyanate groups. R3, R4 and R5 are the same or different and represent hydrogen or organic groups which are inert towards isocyanate groups, and n represents an integer with a value of at least 2, preferably 2 to 4 and more preferably 2. X preferably represents a divalent hydrocarbon group obtained by removal of the amino groups from the primary polyamines and polyetheramines specified below and more preferably represents a divalent hydrocarbon group obtained by removal of the amino groups from the preferred primary polyamines specified below. R1 and R2 are the same or different organic groups and are preferably methyl, ethyl or n-butyl and R3, R4 and R5 are preferably hydrogen.

An organic group which is inert towards isocyanate groups is an organic group which is inert towards isocyanate groups at a temperature of 150° C. or less, e.g. 110° C. or less. Polyaspartic acid esters of Formula (I) are prepared in known manner by reacting the corresponding primary polyamines or polyether amines corresponding to the formula X—(NH2)n with optionally substituted maleic or fumaric acid esters corresponding to the formula R1OOC—CR3=CR4-COOR2. X, R1, R2, R3, R4 and n have the meaning as defined above for Formula (I).

Primary polyamines or polyether amines are preferred for preparing the polyaspartic acid esters as those give a favorable solids/viscosity ratio in order to meet a desired VOC of 4.5 lbs/gal (540 grams/liter) or below of the final surfacer formulation. A molar excess of the polyamines or polyether amines can also be reacted with di- and polyisocyanates to prepare amine terminated ureas or polyether ureas, or can be reacted with isocyanate terminated polyesters, polycarbonates or polyethers obtained from the corresponding polyester, polycarbonate or polyether di- or polyols, and subsequent conversion of the terminal amino groups into an aspartic acid ester through reaction with a maleic and/or fumaric acid ester.

Suitable primary polyamines include ethylene diamine, 1,2-diaminopropane, 1,4-diaminobutane, 1,3-diaminopentane, 1,6-diaminohexane, 2,5-diamino-2,5-dimethylhexane, 2,2,4- and 2,4,4-trimethyl-1,6-diaminohexane, 1,11-diaminoundecane, 1,12-diaminododecane, 1,3- and 1,4-cyclohexane diamine, 1-amino-3,3,5-trimethyl-5-aminomethylcyclohexane (IPDA), 2,4- and 2,6-hexahydrotoluylene diamine, 2,4′- and 4,4′-diamino-dicyclohexyl methane (PACM) and 3,3′-dialkyl-4,4′-diaminodicyclohexylmethanes, such as 3,3′-dimethyl-4,4′-diaminodicyclohexyl methane and 3,3′-diethyl-4,4′-diaminodicyclohexylmethane, 2,4,4′-triamino-5-methyldicyclohexylmethane, 2-methyl-1,5-pentanediamine, 1,3- and 1,4 xylylenediamine and tetramethyl xylylenediamine. Preferred primary polyamines are -IPDA, PACM, 3,3′-dialkyl-4,4′-diaminodicyclohexylmethanes such as 3,3′-dimethyl-4,4′-diaminodicyclohexyl methane and 2-methyl-1,5-pentanediamine.

Suitable polyether polyamines are those with aliphatically bonded primary amino groups. The polyether polyamines can have a molecular weight of about 148 to about 6,000. Examples of suitable polyether polyamines are the products commercially available under the trademark JEFFAMINE® from Huntsman.

Examples of optionally substituted maleic or fumaric acid esters suitable for preparing the polyaspartic acid esters include the dimethyl, diethyl, dibutyl (e. g. di-n-butyl, di-s-butyl, di-t-butyl), diamyl, di-2-ethylhexyl esters and mixed esters based on mixtures of the above groups and/or other alkyl groups; and the corresponding maleic and fumaric acid esters substituted by methyl in the 2- and/or 3-position. The dimethyl, diethyl and dibutyl esters of maleic acid are preferred, while the diethyl esters are especially preferred.

Other diesters which can be used are those derived from cycloaliphatic, bicycloaliphatic and aromatic alcohols, such as cyclohexanol, benzylalcohol and isoborneol. Long chain monoalcohols such as ether alcohols can also be used, e.g., the reaction products of monoalkyl, cycloalkyl and aryl monoalcohols with ethyleneoxide, propyleneoxide, butyleneoxide, such as monobutylglycol, monohexylglycol, propyleneglycol monobutylether.

The preparation of polyaspartic acid esters of Formula (I) from the above mentioned starting materials may be carried out, for example, at a temperature of from 0 to about 150° C. using the starting materials in such proportions that at least one, preferably one, olefinic double bond is present for each primary amino group. Excess of starting materials may be removed by distillation after the reaction. The reaction may be carried out solvent-free or in the presence of suitable organic solvents.

The polyaspartic acid ester may also be a chain-extended aspartate prepolymer and preferably is a chain-extended aspartate prepolymer. It is appreciated that the chain-extended aspartate prepolymer is a reaction product of a mixture comprising at least one di-aspartic acid ester and at least one amino-functional mono-aspartic acid ester. The preparation of suitable chain-extended aspartate prepolymer is for instance described in detail in WO 2015/130502 A1.

For example, the at least one di-aspartic acid ester is a compound of Formula (I) as defined above wherein X, R1, R2, R3, R4, R5 and n are as defined above.

In one embodiment, the at least one di-aspartic acid ester, preferably the compound of Formula (I), is a reaction product of at least one dialkyl maleate and at least one primary diamine. Alternatively, the at least one di-aspartic acid ester, preferably the compound of Formula (I), is a reaction product of at least one dialkyl fumarate and at least one primary diamine.

The at least one amino-functional mono-aspartic acid ester is a compound of Formula (II) and/or (III):

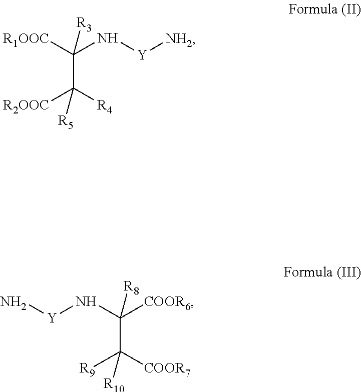

wherein Y represents a divalent organic group, obtained by removal of one amino group from a primary diamine; R₁, R₂, R₆ and R₇ are the same or different organic groups which are inert towards isocyanate groups and preferably are the same organic groups and R₃, R₄, R₅, R₈, R₉ and R₁₀ are the same or different and preferably are the same organic groups and represent hydrogen or organic groups which are inert towards isocyanate groups.

For example, R1, R2, R6 and R7 are preferably methyl, ethyl or n-butyl, such as ethyl. In one embodiment, R3, R4, R5, R8, R9 and R10 are preferably the same and hydrogen.

The at least one amino-functional mono-aspartic acid ester, preferably the compound of Formula (II) and/or (III), is preferably a reaction product of at least one dialkyl maleate and/or dialkyl fumarate and at least one primary diamine. For example, the at least one amino-functional mono-aspartic acid ester, preferably the compound of Formula (II) and/or (III), is a reaction product of at least one dialkyl maleate or dialkyl fumarate and at least one primary diamine.

If the at least one di-aspartic acid ester, preferably the compound of Formula (I), and/or the at least one amino-functional mono-aspartic acid ester, preferably the compounds of Formula (II) and/or (III), is/are a reaction product of at least one dialkyl maleate and at least one primary diamine, the at least one dialkyl maleate is preferably selected from the group comprising dimethyl maleate, diethyl maleate, di-n-butyl maleate, di-iso-butyl maleate, di-tert-butyl maleate, diamyl maleate, di-n-octyl maleate, dilauryl maleate, dicyclohexyl maleate, di-tert-butylcyclohexyl maleate and mixtures thereof. More preferably, the at least one dialkyl maleate is diethyl maleate.

Alternatively, if the at least one di-aspartic acid ester, preferably the compound of Formula (I), and/or the at least one amino-functional mono-aspartic acid ester, preferably the compound of Formula (II) and/or (III), is/are a reaction product of at least one dialkyl fumarate and at least one primary diamine, the at least one fumarate is selected from the group comprising dimethyl fumarate, diethyl fumarate, di-n-butyl fumarate, di-iso-butyl fumarate, di-tert-butyl fumarate, diamyl fumarate, di-n-octyl fumarate, dilauryl fumarate, dicyclohexyl fumarate, di-tert-butylcyclohexyl fumarate and mixtures thereof.

Preferably, the at least one di-aspartic acid ester, preferably the compound of Formula (I), and the at least one amino-functional mono-aspartic acid ester, preferably the compound of Formula (II) and/or (III), are a reaction product of at least one dialkyl maleate and at least one primary diamine, wherein the at least one dialkyl maleate is selected from the group comprising dimethyl maleate, diethyl maleate, di-n-butyl maleate, di-iso-butyl maleate, di-tert-butyl maleate and mixtures thereof. More preferably, the at least one dialkyl maleate is selected from the group comprising dimethyl maleate, diethyl maleate, di-n-butyl maleate and mixtures thereof. Most preferably, the at least one dialkyl maleate is diethyl maleate.

It is appreciated that the at least one di-aspartic acid ester, preferably the compound of Formula (I), and/or the at least one amino-functional mono-aspartic acid ester, preferably the compound of Formula (II) and/or (III), is/are obtained by reacting the at least one dialkyl maleate and/or dialkyl fumarate as described above and at least one primary diamine.

The at least one primary diamine is preferably selected from any of the diamines contained in the group of primary polyamines as defined above in the context of the polyaspartic acid esters of Formula (I) and mixtures thereof. Preferably, the at least one primary diamine is selected from the group comprising IPDA, PACM and 3,3′-dialkyl-4,4′-diaminodicyclohexylmethanes, such as 3,3′-dimethyl-4,4′-diaminodicyclohexyl methane and 3,3′-diethyl-4,4′-diaminodicyclohexylmethane, 2-methyl-1,5-pentanediamine and mixtures thereof. More preferably, the at least one primary diamine is IPDA and/or PACM. Most preferably, the at least one primary diamine is IPDA.

If the polyaspartic acid ester A) is a chain-extended aspartate prepolymer, it is a further requirement that the mixture comprises the at least one di-aspartic acid ester and the at least one amino-functional mono-aspartic acid ester such that the molar ratio between the at least one di-aspartic acid ester, preferably the compound of Formula (I), and the at least one amino-functional mono-aspartic acid ester, preferably the compound of Formula (II) and/or (III), is from 99.5:0.5 to 50:50 and preferably is from 95:5 to 60:40.

It is appreciated that the at least one di-aspartic acid ester, preferably the compound of Formula (I), and/or the at least one amino-functional mono-aspartic acid ester, preferably the compound of Formula (II) and/or (III), is/are preferably obtained by reacting the at least one dialkyl maleate and/or dialkyl fumarate and the at least one primary diamine in an equivalent ratio of dialkyl maleate and/or dialkyl fumarate to primary diamine from 2:1 to 1:4., preferably from 1:1 to 1:3, more preferably from 1.8:1 to 2.2:1 and most preferably of about 2:1.

The mixture of the at least one di-aspartic acid ester, preferably the compound of Formula (I), and the at least one amino-functional mono-aspartic acid ester, preferably the compound of Formula (II) and/or (III), is preferably prepared in known manner by reacting the corresponding at least one dialkyl maleate and/or dialkyl fumarate and at least one primary diamine, for example, at a temperature of from 0 to 150° C. using the starting materials in such proportions that the mixture comprising the at least one di-aspartic acid ester, preferably the compound of Formula (I), and the at least one amino-functional mono-aspartic acid ester, preferably the compound of Formula (II) and/or (III), is obtained. Excess of starting materials can be removed by distillation after the reaction. The reaction may be carried out solvent-free or in the presence of suitable organic solvents.

If the polyaspartic acid ester A) is a chain-extended aspartate prepolymer, it is a further requirement that the chain-extended aspartate prepolymer is obtained by reacting the mixture comprising the at least one di-aspartic acid ester, preferably the compound of Formula (I), and the at least one amino-functional mono-aspartic acid ester, preferably the compound of Formula (II) and/or (III), as defined above and at least one polyisocyanate.

The at least one polyisocyanate can be any kind of organic polyisocyanates with aliphatically, cycloaliphatically, araliphatically and/or aromatically bound free isocyanate groups and preferably is any kind of organic polyisocyanate with cycloaliphatically bound free isocyanate groups. The at least one organic polyisocyanate, preferably at least one cycloaliphatic polyisocyanate, is preferably liquid at room temperature or becomes liquid through the addition of organic solvents.

In one embodiment of the present invention, the at least one polyisocyanate, preferably the at least one cycloaliphatic polyisocyanate, has an average NCO functionality from 1.5 to 6.0, preferably from 1.8 to 4.0 and most preferably of about 3.0.

The at least one polyisocyanate suitable for preparing the chain-extended aspartate prepolymer is preferably selected from the group comprising 1-isocyanato-3,3,5-trimethyl-5-isocyanatomethyl-cyclohexane (IPDI), 4,4′-diisocyanatocyclohexylmethane, cyclotrimers and/or biurets of 1-isocyanato-3,3,5-trimethyl-5-isocyanatomethyl-cyclohexane, hexamethylene diisocyanate (HDI), 1-bis(isocyanatocyclohexyl)-methane and their derivatives, 1,1,6,6-tetramethyl-hexamethylene diisocyanate, p- or m-tetramethylxylylene diisocyanate, 2,2′,5 trimethylhexane diisocyanate and mixtures thereof and reaction products thereof. More preferably, the at least one polyisocyanate is IPDI or HDI, and most preferably is IPDI.

It is appreciated that the chain-extended aspartate prepolymer is preferably obtained by reacting the mixture comprising the at least one di-aspartic acid ester, preferably the compound of Formula (I), and the at least one amino-functional mono-aspartic acid ester, preferably the compound of Formula (II) and/or (III), with the at least one polyisocyanate, preferably the at least one cycloaliphatic polyisocyanate in an equivalent ratio of NH and NH2 groups in the mixture to NCO groups of the at least one polyisocyanate, preferably of the at least one cycloaliphatic polyisocyanate, from 2.0:0.2 to 2.0:1.8, preferably from 2.0:0.4 to 2.0:1.4 and most of about 2.0:0.6.

The chain-extended aspartate prepolymer is preferably prepared in known manner by reacting the mixture comprising at least one di-aspartic acid ester, preferably the compound of Formula (I) and at least one amino-functional mono-aspartic acid ester, preferably the compound of Formula (II) and/or (III), with the at least one polyisocyanate, preferably the at least one cycloaliphatic polyisocyanate, for example, at a temperature of from 0 to 150° C. using the starting materials in such proportions that the chain-extended aspartate prepolymer is obtained. Excess of starting materials may be removed by distillation after the reaction. The reaction may be carried out solvent-free or in the presence of suitable organic solvents.

Accordingly, the chain-extended aspartate prepolymer is preferably a cycloaliphatically chain-extended aspartate prepolymer.

The chain-extended aspartate prepolymer may be further characterized by its equivalent ratio of aspartate groups to urea groups. Preferably, the chain-extended aspartate prepolymer comprises an equivalent ratio of aspartate groups to urea groups from 10:1 to 1:0.9, more preferably from 5:1 to 1:0.9 and most preferably of about 2.0:0.6.

If the polyaspartic acid ester A) is a chain-extended aspartate prepolymer, it is a requirement that the chain-extended aspartate prepolymer is free of isocyanate groups.

If the polyaspartic acid ester A) is a chain-extended aspartate prepolymer, a topcoat applied on the organic solvent-based surfacer coating composition has an even further improved topcoat appearance. Also, if the polyaspartic acid ester A) is a chain-extended aspartate prepolymer, the organic solvent-based surfacer coating composition has an improved potlife with a slower and less steep viscosity increase upon time. Also, if the polyaspartic acid ester A) is a chain-extended aspartate prepolymer, the coating composition is less prone to yellowing upon storage time. Moreover, if the polyaspartic acid ester A) is a chain-extended aspartate prepolymer, a composition for storage comprising components A) and C) and/or D) has particular improved settling behavior upon storage time. Moreover, a chain-extended aspartate prepolymer can be prepared in a molecular weight distribution which fulfills the official REACH (Regulation concerning the Registration, Evaluation, Authorisation and Restriction of Chemicals) polymer definition and therefore can be tailor made, e.g. with respect to functionality per molecule, network density of applied surfacer, etc., without the need of a new expensive REACH registration.

### Component B) of the Surfacer Coating Composition

The surfacer coating composition also comprises a polyisocyanate cross-linking agent with free isocyanate groups. The polyisocyanates can be any number of organic polyisocyanates with aliphatically, cycloaliphatically, araliphatically and/or aromatically bound free isocyanate groups. The polyisocyanates are liquid at room temperature or become liquid through the addition of organic solvents. At 23° C., the polyisocyanates plus organic solvents generally have a viscosity of about 1 to about 3,500 mPas, preferably of about 5 to about 3,000 mPas.

The polyisocyanate cross-linking agents can be used individually or in combination with one another. The polyisocyanate cross-linking agents are those commonly used in the paint industry. They are described in detail in the literature and are also commercially obtainable. The isocyanate groups of polyisocyanate crosslinking agent B) may be partially blocked. Low molecular weight compounds containing active hydrogen for blocking NCO groups are known. Examples of those blocking agents are aliphatic or cycloaliphatic alcohols, dialkylamino alcohols, oximes, lactams, imides, hydroxyalkyl esters and esters of malonic or acetoacetic acid.

Preferably, the surfacer coating composition comprises at least one aromatically bound polyisocyanate cross-linking agent with free isocyanate groups with an average NCO functionality of about 1.5 to about 6, preferably about 2 to about 6. If at least one aromatically bound polyisocyanate cross-linking agent with free isocyanate groups is used, the overall reactivity of the surfacer coating composition is enhanced.

Examples of suitable polyisocyanates are what are known as “paint polyisocyanates” based on hexamethylene diisocyanate (HDI), 1-isocyanato-3,3,5-trimethyl-5-isocyanatomethyl-cyclohexane (IPDI) and/or bis(isocyanatocyclohexyl)-methane and their derivatives. Typically, following production, the derivatives are freed from surplus parent diisocyanate, preferably by distillation, with only a residue content of less than about 0.5% by weight. Triisocyanates, such as triisocyanatononan can also be used.

Sterically hindered polyisocyanates are also suitable. Examples of these are 1,1,6,6-tetramethyl-hexamethylene diisocyanate, 1,5-dibutyl-penta-methyldiisocyanate, p- or m-tetramethylxylylene diisocyanate and the appropriate hydrated homologues.

Examples of aromatically bound polyisocyanate cross-linking agent are based on 4,4′-biphenylene diisocyanate, toluene diisocyanate, tetramethylene xylene diisocyanate, 1,3-phenylene diisocyanate, 1,5-naphthalene diisocyanate, 4,4′-diisocyanatodiphenyl ether,
triphenylmethane triisocyanate, 1,3,5-benzene triisocyanate and 2,4,6-toluene triisocyanate. For instance, a commercial available toluene diisocyanate is Desmodur® L67 BA from Covestro.

In principle, diisocyanates can be converted by the usual processes to higher functional compounds, for example, by trimerization or by reaction with water or polyols, such as, for example, trimethylolpropane or glycerine. The polyisocyanates can also be used in the form of isocyanate-modified resins or isocyanate-functional pre-polymers. Generally, the polyisocyanates can be isocyanurates, uretdione diisocyanates, biuret group-containing polyisocyanates, urethane group-containing polyisocyanates, allophanate group-containing polyisocyanates, isocyanurate and allophanate group-containing polyisocyanates, carbodiimide group-containing polyisocyanates and polyisocyanates containing acylurea groups.

### Surfacer Coating Composition

In addition to components A) and B) the surfacer coating composition contains C) at least one pigment and/or extender and D) at least one organic solvent. The organic solvents may originate from the preparation of the binders or they may be added separately. They are organic solvents typically used for coating compositions and well known to the skilled person. The pigments and extenders can be any conventional organic and/or inorganic color-imparting pigments and extenders as are known to the person skilled in the art for the production of coating compositions, in particular for the production of surfacer coating compositions in the vehicle coating sector. Examples of pigments are titanium dioxide, micronized titanium dioxide, iron oxide pigments, carbon black, azo pigments, phthalocyanine pigments, quinacridone and pyrrolopyrrole pigments. Examples of extenders are silicon dioxide, aluminium silicate, aluminium oxide, carbonates, barium sulphate, kaolin and talcum.

The surfacer coating compositions generally have a weight ratio of extenders and pigments to binder solids of preferably about 4.0:1.0 to about 1.0:2.0, particularly preferably, of about 2.5:1.0 to about 1.0:1.0. The pigment volume concentration (PVC) is, for example, in the range of about 20 to about 65% for surfacer coating compositions in general and in the range of about 20 to about 45% for wet on wet surfacer coating compositions. The PVC is the ratio of volume of pigments/extenders to total volume of all non-volatile components of the composition (including pigments/extenders, binders, additives etc.) in percent.

The surfacer coating composition may also contain additives. The additives are the conventional additives, which may be used, in the coating sector. Examples of such additives typical for use in surfacer coating compositions include levelling agents, e.g., based on (meth)acrylic homopolymers or polyether modified polydimethylsiloxanes, anti-cratering agents, antifoaming agents, wetting agents, curing catalysts for the cross-linking reaction, dispersing agents, thickeners, emulsifiers and water scavengers. The additives are used in usual quantities known to a skilled person.

In principle, the surfacer coating composition can still be adjusted to spray viscosity with organic solvents prior to application. Also a further component can be used as so-called reducer containing solvents and optionally further ingredients like catalysts or other additives. All the further components which are required for producing a usable surfacer coating composition, such as for example pigments, extenders, organic solvents and additives, may in each case be present in one of the two components, in both components, in the reducer of the two-component system or in an additional component (i.e a converter).

Suitable catalysts are commonly known by the skilled person and may be selected from the groups of tin catalysts as for example dibutyltin dilaurate (DBTL), amine catalysts as for example 1,4-diazabicyclo[2.2.2]octane (DABCO), 1,8-Diazabicyclo[5.4.0]undec-7-en (DBU), 1,5-diazabicyclo-[4,3,0]-non-5-ene (DBN), 1,1,3,3-tetramethylguanidine (TMG), metal carboxylate catalysts as for example zinc-octoate, zinc-naphthenate, zinc- or bismut-neodecanoate, organic acid catalysts as for example acetic acid, oleic acid, benzoic acid or salicylic acid, OH-functional solvents, oligomers or polymers and water. Other suitable catalysts are also described in WO 2014/106578 A1. One or more catalysts can be used.

The surfacer coating compositions can optionally be adjusted by different amounts and combinations of catalysts to account for different temperature and humidity conditions during the application and flash off time of the surfacer.

In addition to components A)-D) the surfacer coating composition preferably comprises E) at least one additional binder component, for example cross-linkable binders with functional groups containing active hydrogen. These binders may be monomeric, oligomeric and/or polymeric compounds with a number average molecular weight (Mn) of, e.g., about 500 to about 200,000 g/mole, preferably of about 1100 to about 100,000 g/mole. The functional groups with active hydrogen can be hydroxyl and/or amino groups. The additional binder component E) is preferably selected from the group consisting of hydroxy-functional binders, amino-functional binders, aminoalcohol-functional binders, polyaspartic acid ester binders different from A), aldimines and/or ketimines.

Binders with hydroxyl groups are for example the polyurethanes, (meth)acrylic copolymers, polyesters and polyethers, known from polyurethane chemistry to the skilled person, which are used in the formulation of organic solvent based coating compositions. They may each be used individually or in combination with one another.

Examples of additional binders or reactive diluents with amino groups are, for example, oligomeric or polymeric blocked amines, such as oligomeric or polymeric ketimines and/or aldimines. Suitable ketimines and aldimines are disclosed, for example, in FARBE&LACK 3/2004, page 94-97, in DE4415778 or in EP05312249. The surfacer coating composition to be used in the process contemplated herein can comprise about 4 to about 40% by weight solids, preferably about 4 to about 20% by weight solids, relative to the total amount of the surfacer coating composition, of the at least one polyaspartic acid ester A). The surfacer coating composition can also comprise up to about 20% by weight solids, relative to the total amount of the surfacer coating composition, of the other cross-linkable binders, for example about 1 to about 10% by weight solids, relative to the total amount of the surfacer coating composition. According to one embodiment the surfacer coating composition can comprise about 1 to about 20% by weight solids, relative to the total amount of the surfacer coating composition, of aldimines and/or ketimines.

In vehicle body or vehicle body part coating, specifically in vehicle body or vehicle body part repair coating surfacer coating compositions are preferably applied by means of spraying, onto the substrates. Even more preferably, in the process contemplated herein the organic solvent-based surfacer coating composition is applied using a manual pressure feed spray gun, a suction feed spray gun, airless and/or airmix techniques, pressure pot techniques and/or non-manual automated techniques. These techniques are commonly known by the skilled person.

The surfacer coating compositions are applied, for example, in a resulting dry film thickness of about 15 to about 400 μm.

In step (ii) of the process contemplated herein, the surfacer layer which has been applied in step (i) of the process contemplated herein is flashed off. Flashing off a coating composition which has been coated to a substrate is in general commonly known by the skilled person and means that the coating composition which has been coated to a substrate is left as sprayed for a certain time period so that for instance at least a certain amount of solvent can evaporate and any potential curing reaction of components of the coating composition may start and/or proceed. Normally, flashing off is performed at ambient temperatures such as from about 20° C. to about 25° C., but may also be performed at slightly elevated temperatures, for instance up to about 40° C. Further, flashing of may be performed at any humidity and is normally performed at ambient humidity, such as from about 10% to about 90% and preferably from about 30% to about 80%. Flashing off may be performed in any areas where vehicles or parts may be painted and optionally in areas where afterwards the topcoat or basecoat and clearcoat are applied. Preferably this is in a spraybooth or any other useful coating facility with optionally controlled air circulation and/or controlled temperature.

Preferably, flashing off the surfacer layer is performed for 15 minutes or less, such as for instance for 1-15 minutes, 2-15 minutes or 3-12 minutes, and even more preferably for 5 to 10 minutes.

In step (iii) of the process contemplated herein, in order to provide a full multilayer coating such as a repair multilayer coating the surfacer layer is over-coated with a top coat after step (ii) of the process contemplated herein. The top coat layer is preferably be formed by applying a base coat layer of a base coat coating composition containing color-imparting and/or special effect-imparting pigments, preferably of a water-based base coat coating composition, and a clear coat layer of a transparent clear coat coating composition onto the base coat layer, or is preferably be formed by applying a single-stage top coat layer of a single-stage top coat coating composition containing color-imparting and/or special effect-imparting pigments.

The base coat coating composition contains the conventional constituents of a water-based pigmented base coat coating composition such as: color-imparting and/or special effect-imparting pigments, one or more binders, water and/or organic solvents and optionally crosslinking agents and conventional coating additives.

Once the base coat coating composition has been applied a clear coat coating composition can be applied. The clear coat coating composition may be applied onto the base coat layer either after drying or curing or after flashing off, for example, at room temperature. Preferably the clear coat coating composition comprises a “two-component” coating composition, i.e. comprises components which are reactive towards one another, namely a binder component comprising active hydrogen and a polyisocyanate crosslinking agent. Preferred clear coat coating compositions comprise at least one hydroxyl-functional (meth)acrylate resin, optionally in combination with at least one hydroxyl-functional oligomeric polyester and at least one polyisocyanate. The clear coating compositions may contain usual coating additives and organic solvents. Preferably, the clear coat layer comprises at least one polyaspartic acid ester such as for instance defined by Formula (I) above or a chain extended aspartate prepolymer such as for instance defined above and at least one polyisocyanate cross-linking agent with free isocyanate groups such as for instance defined above for component (B) of the surfacer coating composition and the base coat layer optionally comprises at least one polyisocyanate cross-linking agent with free isocyanate groups such as for instance defined above for component (B) of the surfacer coating composition.

Alternatively a single-stage top coat layer of a pigmented single-stage top coat composition can be applied onto the surfacer layer. The single-stage top coat coating composition contains conventional coating pigments, for example, effect-imparting pigments and/or color-imparting pigments selected from among white, colored and black pigments. Preferably the single-stage top coat coating composition comprise a “two-component” coating composition, i.e. comprises components which are reactive towards one another, namely a binder component comprising active hydrogen and a polyisocyanate crosslinking agent.

The resultant two-layer or single-stage top coat layers may be cured at room temperature or forced dried at higher temperatures, for example, of up to about 80° C., preferably at about 40 to about 60° C. The coating compositions are applied by conventional processes, preferably by means of spray application.

The process contemplated herein can be used in automotive and industrial coating, however, particularly advantageously in vehicle repair coating as well as in heavy vehicle coating and industrial coating.

In case the substrate is a metal substrate, the metal substrate preferably comprising vehicle bodies or vehicle body parts, the process contemplated herein preferably comprises an additional step of pretreating the substrate to be coated with an acidic aqueous composition comprising a) phosphate ions and/or b) a water-soluble titanium and/or c) zirconium compound and water and, optionally, a step of subjecting the pre-treated substrate to a flash-off phase. Such step of pretreatment is described in EP 2862957 A1. The pretreatment of the metal substrate is performed prior to step (i) of the process contemplated herein.

The term “pretreatment composition” shall be used here and in the following for the acidic aqueous composition as defined above.

In the optional step of pretreating the metal substrate, the metal substrate to be coated or repair coated is pretreated with the pretreatment composition. In particular in case of a repair coating process the blemished area to be repair coated, e.g., on a vehicle body or vehicle body part, can be prepared in conventional manner, if necessary, before pretreating the metal substrate with the pretreatment composition. The blemished area and optionally also the bordering transition zone between the blemished area and the intact existing coating may, for example, be prepared by cleaning, sanding and re-cleaning. The sanded repair surface can be cleaned with conventional cleaning agents, for example, low VOC surfacer cleaners or silicone removers. After the optional preparation step the metal substrate is pretreated with the pretreatment composition comprising a) phosphate ions and/or b) water-soluble titanium and/or zirconium compounds, and c) water.

Preferably the pretreatment composition comprises about 1 to about 25% by weight, more preferred about 1 to about 16% by weight, relative to the total amount of the pretreatment composition, of phosphate ions, and/or about 0.3 to about 3% by weight, more preferred about 0.5 to about 1% by weight, relative to the total amount of the pretreatment composition, of the at least one water-soluble titanium and/or zirconium compound, calculated as elemental titanium and zirconium. Phosphate ions can be present, for example, in form of dissociated ortho-phosphoric acid and/or ortho-phosphoric acid salts, such as ammonium hydrogen phosphates.

Preferably, water-soluble titanium and/or zirconium compounds are titanium or zirconium containing complex fluoro acids, such as hexafluoro titanium acid and hexafluoro zirconium acid as well as fluoro complexes of titanium or zirconium, such as hexafluoro titanates or hexafluoro zirconates, such as di-potassium hexafluoro zirconate, di-sodium hexafluoro zirconate, ammonium hexafluoro zirconate, magnesium hexafluoro zirconate, di-lithium hexafluoro zirconate and the analogous titanium complexes. The water-soluble titanium and/or zirconium compounds can be used alone or in combination with one another. Most preferably, the water-soluble titanium and/or zirconium compounds are selected from hexafluoro titanium acid, hexafluoro zirconium acid or a combination of both.

In an exemplary embodiment, the pretreatment composition has a pH value of <7, preferably of about 1 to about 4.

The pretreatment composition can contain about 30 to about 99% by weight of water.

The pretreatment composition can further contain additional ingredients, for example, compounds acting as sources of free fluoride, such as hydrofluoric acid, H2SiF6 and KF, oxidizing agents or accelerators such as H2O2, HNO2, HNO3 and HClO4, additional metal ions such as Zn(II), Mn(II) and Ni(II) and organic solvents such as butyl glycol. Even if not preferred, Cr6+ ions can also be present in the pretreatment composition. Examples of additional ingredients are described in EP 1571237, DE 10322446 and DE 10322446.

The phosphate ions and the water-soluble titanium and/or zirconium compound can be called as active ingredients of the pretreatment composition. The pretreatment composition can contain as active ingredient the phosphate ions alone or the water-soluble titanium and/or zirconium compound alone or a combination of both. According to one embodiment the pretreatment composition contains phosphoric acid, according to another embodiment the pretreatment composition contains hexafluoro titanium and/or hexafluoro zirconium acid, and according to yet another embodiment the pretreatment composition contains a mixture of phosphoric acid and hexafluoro titanium acid and/or hexafluoro zirconium acid. Preferably, the pretreatment composition comprises phosphoric acid.

The pretreatment composition can be applied in various ways. One option is to apply it by spraying. A further option is applying the pretreatment composition by wiping, e.g., with a cloth soaked in the pretreatment composition. Preferably, the acidic composition is applied by wiping, even more preferably by wiping with a cloth soaked in the acidic aqueous solution. After application of the pretreatment composition a metal oxide conversion layer is formed on the metal substrate surface. Typically, the metal oxide conversion layer is very thin and has a layer thickness of <1 μm.

Suitable cloths to be used for wiping are, for example, those available under the tradename Sontara® from DuPont or any other cleaning tissues to be disposed of after use.

Suitable pretreatment compositions are also commercially available, for example, under the trade name 5717S from Cromax® Refinish (phosphoric acid based). Suitable cloths soaked in the pretreatment composition are also commercially available, for example, under the trade name Cromax® PS1800 Metal Pretreatment Wipes from Axalta Coating Systems GmbH & Co.KG.

After pretreatment of the metal substrate with the pretreatment composition a flash-off phase is preferably provided in order to allow the solution to form the metal oxide conversion layer and to evaporate water and optionally present organic solvents. For example, a flash-off phase of about 1 to about 2 minutes at about 20 to about 23° C. may be provided. Flashing off may be accelerated with warm air. Hence, the total time needed for application of the pretreatment composition and flashing off may be in the range of about 3 minutes to about 5 minutes. A rinsing step with water or with other special solutions for surface post treatment or passivation can be included, which may help to further enhance adhesion and corrosion protection of the paint system. Special solutions are, e.g., products commercially available from Cromax® Refinish under the product name 5718S.

The process contemplated herein will be explained in more detail on the basis of the examples below. All parts and percentages are on a weight basis unless otherwise indicated.

### EXAMPLES

### Inventive Examples (IE) 1: Preparation of Surfacer Coating Compositions

Surfacer coating compositions IE 1.1 and IE 1.2 have been prepared with the ingredients shown in Table 1.

TABLE 1

| | IE 1.1 | IE 1.2 |
|---|---|---|
| Component 1 | | |
| POLYASPARTIC ACID ESTER (1) | 24.1 | |
| POLYASPARTIC ACID ESTER (2) | | 13.8 |
| SOLVENT MIX (3) | | 6.1 |
| IRONOXIDE BLACK | 0.8 | 0.8 |
| TiO₂ | 7.6 | 7.5 |
| BARIUMSULFATE | 15.2 | 15.1 |
| TALCUM | 2.5 | 2.5 |
| KAOLIN | 4.6 | 4.6 |
| ZINKPHOSPHATE | 4.0 | 4.0 |
| Additions after dispersion step | | |
| SOLVENT MIX (3) | 11.7 | 6.8 |
| Component 2 | | |
| POLYISOCYANATE HARDENER (4) | 29.5 | 38.8 |
| SUM | 100.0 | 100.0 |

(1) Inventive example 3 (IE3) from WO 2015130502 A1
(2) Desmophen ^{®} NH 1420 from Covestro
(3) 1/1/1 mixture of butyl acetate, methoxypropyl acetate and xylene
(4) Desmodur ^{®} L67 BA/Desmodur ^{®} N 3900 (both from Covestro)/Butylacetate/Ethylacetate: 22.2/16.5/29.5/31.8 (% weight)

The two compositions in Table 1 are formulations without additives, auxiliary further reactive or unreactive components. Both formulations have the same formulation parameters, which are the NCO/NH stoichiometry (1.1), the pigment volume concentration (30%) and the theoretical volatile organic compounds according to EU VOC legislation (525 g/L) and are therefore comparable. These formulations achieve the superior combination of fast overcoatability, early de-nibbing and high end topcoat appearance.

### Inventive Examples (IE) 2: Ready for Use Surfacer Coating Compositions Mixed from Commercially Available Products

TABLE 2

| | IE 2.1 | IE2.2 |
|---|---|---|
| surfacer | SH5500 | SH5500* (NH1420) |
| clearcoat | SH8800 | SH8800 |
| hardener | SH3550 | SH3550 |
| thinner | SH3380 | SH3380 |
| Mixing by weight | 100/6/60/10 | 100/6/70/5 |

SH5500: Permasolid ^{®} HS Speed Surfacer 5500
SH8800: Permasolid ^{®} HS Speed Clear Coat 8800
5H3550: Permasolid ^{®} Hardener 3550
SH3380: Permacron ^{®} Reducer 3380

The SH5500 formulation in IE2.1 is commercially available and based on a chain extended aspartate. SH5500* is a modified SH5500 formulation, where the chain extended aspartate was exchanged by the non-chain extended Desmophen® NH1420 from Covestro in a way that in the ready for use mixture the formulation parameters (stoichiometry, pigment volume concentration and the volume solids) are not changed. These formulations are therefore comparable.

Comparative examples 3 (CE 3): commercial available surfacer compositions currently used in wet on wet application processes.

TABLE 3

| | CE 3.1 | CE 3.2 | CE 3.3 | CE 3.4 |
|---|---|---|---|---|
| Surfacer | PS1064 | NS2602 | Sikkens ^{®} | Glasurit ^{®} |
| | | | Autosurfacer rapid | 285-31 |
| Hardener | XK205 | XK205 | Autosurfacer rapid | 929-56 |
| | | | hardener | |
| Thinner | AZ9032 | XB383 | Autosurfacer rapid | 523-15 |
| | | | non sanding reducer | |
| Mixing by weight | 100/17/23 | 100/16/19 | | |
| Mixing by volume | | | 3/1/2 | 3/1/1 |
| Technical data-sheet | EN PS106x-4 | EN NS206x-7 | EU.3.2.28, | 285-31 02/16 |
| (TDS) versions | 07.12.16 | 15.12.16 | 31.07.2015 | 523-15 01/16 |

PS1064: Cromax ^{®} Pro Surfacer PS1064
XK205: Cromax ^{®} AR7305/XK205 activator
AZ9032: Cromax ^{®} AZ9032 wet on wet converter
NS2602: Cromax ^{®} NS2602 Non-sanding Primer-Surfacer
XB383: Cromax ^{®} Thinner XB383
285-31: Glasurit ^{®} HS VOC Non-Sanding Filler 285-31
929-56: Glasurit ^{®} Hardener 929-56
523-15: Glasurit ^{®} Racing Additive 523-15

CE 3.1 and CE 3.2 are surfacer coating compositions which are commercially available from Axalta Coating Systems Gmbh & Co. KG and which are widely used in the vehicle body refinishing. These surfacer coating compositions can also be used for the first OEM coating of commercial vehicles.

The composition of CE 3.1 is based on a two-component polyurethane sanding surfacer to which the binder solution AZ9032 (“thinner or converter”) is added to convert the original two-component polyurethane sanding surfacer to a wet on wet surfacer by reducing the pigment volume concentration and improving the spray performance and surface leveling. The surfacer PS1064 used in CE 3.1. does not contain a polyaspartic acid ester component.

CE 3.2 is a widely used productive two-component polyurethane surfacer which is overcoatable after 15 minutes air dry time, with good wet on wet application properties, and with long potlife. Additionally, it can be applied on bare metal without using a primer. The surfacer NS2602 used in CE 3.2. does not contain a polyaspartic acid ester component.

CE 3.3 is an isocyanate free high productive surfacer, which can be overcoated after 15 minutes air dry time and which is based on special acrylic binders in the base material and blocked polyamines with high molecular weight in the activator.

CE 3.4 is a very productive two-component polyurethane wet on wet surfacer with a recommended flash off time of 10 minutes. Chemical crosslinking is accelerated by high amounts of DBTL catalyst.

After mixing of all components of the compositions of IE 1, IE 2 and CE 3, the viscosities of the obtained mixtures were measured in an Iso-3 cup according to DIN EN ISO 2431 and in a Din-4 cup according to DIN 53 211. The potlife was measured as the viscosity increase in 15 minutes time intervals in a Din-4 cup.

TABLE 4
potlife of examples 1-3:

| Example | IE 1.1 | IE 1.2 | IE 2.1 | IE 2.2 | CE 3.1 | CE 3.2 | CE 3.3 | CE 3.4 |
|---|---|---|---|---|---|---|---|---|
| Mix viscosity | 59 | 48 | 53 | 48 | 79 | n.m.* | n.m.* | n.m.* |
| ISO3-cup [s] | | | | | | | | |
| Mix viscosity | 13.5 | 12.5 | 13 | 12.5 | 17 | 20 | 22 | 21.5 |
| DIN4-cup [s] | | | | | | | | |
| 15 minutes | 16 | 14 | 14 | 13 | 18 | 21 | 24 | 29 |
| 30 minutes | 19 | 16.5 | 15.5 | 14 | 19 | 23 | 27 | 75 |
| 45 minutes | 25 | 21 | 17 | 15 | 19 | 23 | 30 | n.m.* |
| 60 minutes | 31 | 27 | 18 | 16 | 20 | 26 | 34 | |
| 75 minutes | 47 | 39 | 20 | 17 | 22 | 29 | 39 | |
| 90 minutes | 69 | 65 | 22 | 18 | 23 | 31 | 46 | |

*not measurable

Higher spray viscosities at the time of application of the surfacer lead to more film structure after application. Any increased film structure will still be visible after topcoat application and results in a weaker topcoat appearance. A slow viscosity increase after mixing of all components is therefore desirable.

### Example 4: Application of the Ready for Use Compositions of IE 1, IE 2 and CE 3 in Combination with a Water Borne Basecoat

30×60 cm GARDOBOND® 26S/60/OC steel panels from Chemetal coated with Electrocoat AquaEC™ 3000 from Axalta Coating Systems Gmbh & Co. KG (referred to as “E-coated steel panels” in the following) were prepared for the coating process by buffing and cleaning according to the typical preparation procedures known by a person skilled in the art.

For the compositions of IE 1 and IE 2 additionally GARDOBOND® OMBS35 degreased 10×20 cm steel panels from Chemetal were prepared for the coating process by sanding and cleaning according to the typical preparation procedures known by a person skilled in the art. Cromax® PS1800 Metal Pretreatment wipes commercially available from Axalta Coatings Systems Gmbh & Co. KG were applied and used according to the technical datasheet. These panels are called “pretreated steel panels” in the following. The comparative examples 3 were not applied and tested on these pretreated steel panels, because such multilayer coating processes are not recommended in the respective technical datasheets of the market references.

Ready for use surfacer coating compositions were mixed according to Table 2 and Table 3 and applied at a temperature of 22° C. and a relative humidity of 45% on the substrates with a Sata RP 5000-1.3 mm nozzle spray gun in a full coat followed by a light coat (1.5 coats).

All surfacer coating compositions were overcoated with commercially available refinish waterborne basecoat (Permahyd Hi-Tec Base Coat 480 in RAL5010 from Spies Hecker) and a refinish solventborne clearcoat (Permasolid HS Clearcoat 8055 from Spies Hecker) after 5 minutes flash off time at 22° C. and 45% relative humidity. Additionally, in separate experiments, the surfacer coating compositions of examples 3.1-3.4 were overcoated with the same basecoat and clearcoat as above after the minimum flash off times recommended in the respective technical datasheets of these surfacers also at 22° C. and 45% relative humidity. After clearcoat application the paint systems were baked for 30 minutes at 60° C. The appearance of the paint systems was measured 24 hours after clearcoat bake and storage of panels at ambient temperatures with a Byk Gardner Wave-Scan Dual (catalog number 4840).

TABLE 5
Results of the wet on wet application process with waterborne basecoat and solventborne
clearcoat on the E-coated steel panels and the pretreated steel panels:

| | Inventive examples | | | | Market references | | | | Market references | | | |
|---|---|---|---|---|---|---|---|---|---|---|---|---|
| | flashed off 5 | | | | flashed off 5 | | | | flashed off | | | |
| | minutes | | | | minutes | | | | according to TDS | | | |
| | IE | IE | IE | IE | CE | CE | CE | CE | CE | CE | CE | CE |
| example | 1.1 | 1.2 | 2.1 | 2.2 | 3.1 | 3.2 | 3.3 | 3.4 | 3.1 | 3.2 | 3.3 | 3.4 |
| coats | 1.5 | 1.5 | 1.5 | 1.5 | 1.5 | 1.5 | 1.5 | 1.5 | 1 | 1.5 | 1 | 1.5 |
| sprayability* | 8 | 8 | 8 | 8 | 8 | 8 | 8 | 8 | 8 | 8 | 8 | 8 |
| flow wet* | 7 | 7 | 7 | 7 | 7 | 7 | 6 | 6 | 7 | 7 | 6 | 6 |
| flash off time before | 5 | | | | | | | | 30 | 15 | 15 | 10 |
| base-coat application | | | | | | | | | | | | |
| [min] | | | | | | | | | | | | |
| film thickness (μm) | 30 | 30 | 27 | 22 | 35 | 34 | 30 | 41 | 34 | 35 | 30 | 41 |
| Basecoat | Permahyd ® Hi-Tec Base Coat 480 in RAL5010 | | | | | | | | | | | |
| | (TDS version: EN/480_0A.5) | | | | | | | | | | | |
| base coat film | 13 | 12 | 13 | 13 | 12 | 12 | 10 | 11 | 12 | 11 | 11 | 11 |
| thickness | | | | | | | | | | | | |
| Clearcoat | Permasolid ® HS Clearcoat 8055/SH3225/SH9034 | | | | | | | | | | | |
| | (TDS version: EN/8055A.10) | | | | | | | | | | | |
| clear coat film | 44 | 42 | 43 | 42 | 49 | 49 | 44 | 42 | 48 | 48 | 45 | 45 |
| thickness | | | | | | | | | | | | |

Appearance after 24 hours (wavescan)

| | | | | | | | | | | | | |
|---|---|---|---|---|---|---|---|---|---|---|---|---|
| DOI | 96 | 94 | 96 | 96 | 89 | 90 | 89 | 88 | 88 | 89 | 92 | 88 |
| dullness | 1 | 2 | 1 | 2 | 7 | 6 | 6 | 8 | 8 | 6 | 3 | 8 |
| Tension | 22 | 19 | 22 | 21 | 20 | 21 | 20 | 19 | 20 | 20 | 21 | 19 |
| Shortwave | 8 | 16 | 6 | 6 | 25 | 22 | 27 | 28 | 26 | 26 | 19 | 28 |
| Longwave | 3 | 6 | 3 | 3 | 4 | 4 | 5 | 5 | 4 | 4 | 4 | 6 |

Scratch hardness and de-nibbing capability of all applied surfacer films were tested 5, 10 and 15 minutes after application in a separate experiment on E-coated steel panels also at 22° C. and 45% relative humidity. The results are shown in Table 6 below. Scratch hardness is a hardness test of the applied surfacer done by the operator with the fingernail. De-nibbing is a careful removal of surface imperfections with a soft and fine sanding pad by hand. Mirka Abralon® 1000 sanding pads were used.

TABLE 6
Scratch hardness and de-nibbing capability development
during flash off time of the applied surfacer

| | | | | | Market references | | | |
|---|---|---|---|---|---|---|---|---|
| | Inventive examples | | | | CE | CE | CE | CE |
| example | IE1.1 | IE1.2 | IE2.1 | IE2.2 | 3.1 | 3.2 | 3.3 | 3.4 |
| film thickness (μm) | 30 | 30 | 27 | 22 | 27 | 26 | 22 | 36 |
| scratch hardness* | 2 | 1 | 1 | 3 | 0 | 0 | 1 | 0 |
| after 5 min | | | | | | | | |
| scratch hardness* | 4 | 4 | 3 | 5 | 0 | 0 | 2 | 1 |
| after 10 min | | | | | | | | |
| scratch hardness* | 5 | 5 | 5 | 6 | 1 | 1 | 2 | 3 |
| after 15 min | | | | | | | | |
| de-nibbing* after 5 min | 5 | 4 | 4 | 6 | 0 | 0 | 1 | 0 |
| de-nibbing* after 10 min | 7 | 7 | 7 | 8 | 0 | 0 | 6 | 5 |
| de-nibbing* after 15 min | 9 | 9 | 9 | 9 | 2 | 3 | 7 | 7 |

*Ratings taken by the applicator. Meaning of ratings from 0 to 10:
0 = totally unacceptable
1 = very poor
2 = poor
3 = poor fair
4 = fair
5 = fairly good, but not commercially acceptable
6 = good
7 = good very good
8 = very good
9 = excellent
10 = perfect

The compositions of IE 1 and IE 2 show the desired and superior combination of high end topcoat appearance and fast productivity. None of the examples 3.1-3.4 is as fast in scratch hardness development and early de-nibbing capability as the compositions of IE1 and IE2. Additionally, CE 3.1-3.4 do not reach the high end topcoat appearance if overcoated after 5 minutes flash off time. The compositions of CE 3.1-3.4 do not even meet the topcoat appearance of IE1 and IE2, if the flash off times are extended to the flash off times recommended in the respective technical datasheets.

Another advantage of the compositions of IE2.1 and IE2.2 is the long potlife as shown in Table 4 above. The low spray viscosities and the slow increase of viscosities with time ensure good sprayability, an even flow of the applied surfacer and less structure buildup of the full paint system leading to superior topcoat appearance.

Additionally, overlapping zones of applied surfacer coats of the inventive examples IE1 and IE2 look smooth, without edge mapping and do not show objectionable spray dust which does not melt into already applied or subsequently applied surfacer coats (so called over- or underspray) and which stays visible after topcoat application.

### Example 5: Humidity and Corrosion Protection Tests

Paint systems applied on E-coated steel panels obtained as described above were stored for seven days at ambient temperatures and tested. Humidity tests according to DIN EN ISO 6270 (240 h, 40° C., 100% humidity) and high pressure cleaning tests according to Volkswagen Norm PV1503 method B were performed. A cross hatch test was performed according to DIN EN ISO 2409 (2 mm distance of scratches, pull off with Tesa 4657 tape).

TABLE 7
Humidity test results of IE 1, IE 2 and CE 3 on E-coated steel panels

| | Inventive examples | | | | | | | | Market references | | | |
|---|---|---|---|---|---|---|---|---|---|---|---|---|
| | flashed off 5 | | | | Market references | | | | flashed off according | | | |
| | minutes | | | | flashed off 5 minutes | | | | to TDS | | | |
| | IE | IE | IE | IE | CE | CE | CE | CE | CE | CE | CE | CE |
| example | 1.1 | 1.2 | 2.1 | 2.2 | 3.1 | 3.2 | 3.3 | 3.4 | 3.1 | 3.2 | 3.3 | 3.4 |
| High pressure | 0 | 0 | 0 | 0-1 | 3-4*** | 3*** | 2-3*** | 0-1 | 1-2 | 0-1 | 3*** | 0-1 |
| cleaning VW | | | | | | | | | | | | |
| PV1503B [mm] | | | | | | | | | | | | |
| cross hatch | 0 | 0 | 0 | 0 | 0 | 0 | 0-1 | 0 | 0 | 0 | 2*** | 0 |
| (initial)** | | | | | | | | | | | | |

240 h humidity test. Evaluations after humidity test:

| | | | | | | | | | | | | |
|---|---|---|---|---|---|---|---|---|---|---|---|---|
| blisters after 1 h | 0/0 | 0/0 | 0/0 | 0/0 | 0/0 | 0/0 | 0/0 | 0/0 | 0/0 | 0/0 | 0/0 | 0/0 |
| [quantity/size]* | | | | | | | | | | | | |
| blisters after | 0/0 | 0/0 | 0/0 | 0/0 | 0/0 | 0/0 | 0/0 | 0/0 | 0/0 | 0/0 | 0/0 | 0/0 |
| 24 h | | | | | | | | | | | | |
| [quantity/size]* | | | | | | | | | | | | |
| cross hatch | 0 | 0 | 0 | 0 | 5*** | 0 | 0 | 0 | 0 | 0 | 0 | 0 |
| after 1 h** | | | | | | | | | | | | |
| cross hatch | 0 | 0-1 | 0 | 0 | 0 | 0 | 5*** | 0 | 0 | 0 | 5*** | 0 |
| after 24 h** | | | | | | | | | | | | |

*Assessment of degree of blistering according DIN EN ISO 4628-2: 0: no blisters, 5: dense/big blisters
**Assessment of cross hatches according to DIN EN ISO 2409; 2 mm grid; pull off one time with Tesa 4657 tape; double determination; mean of two crosshatches documented.
***Split between surfacer and basecoat

The compositions of IE1 and IE2 perform very well in high pressure cleaning and adhesion tests before and after humidity exposure. Examples 3.1, 3.2 and 3.3 show weaknesses either in high pressure cleaning and/or in adhesion tests specially if the flash off times are reduced to 5 minutes.

TABLE 8
Humidity test results of IE 1 and IE 2 on pretreated
steel panels prepared as described above

| | Inventive examples | | | |
|---|---|---|---|---|
| example | IE1.1 | IE1.2 | IE2.1 | IE2.2 |
| High pressure cleaning VW | 0 | 0 | 0 | 0-1 |
| PV1503B [mm] | | | | |
| cross hatch (initial)** | 1 | 1 | 0 | 0 |

240 h humidity test. Evaluations after humidity test:

| | | | | |
|---|---|---|---|---|
| blisters after 1 h [quantity/size]* | 0/0 | 0/0 | 0/0 | 0/0 |
| blisters after 24 h [quantity/size]* | 0/0 | 0/0 | 0/0 | 0/0 |
| cross hatch after 1 h** | 0 | 0 | 0 | 0 |
| cross hatch after 24 h** | 0-1 | 1 | 0 | 0 |

*Assessment of degree of blistering according DIN EN ISO 4628-2: 0: no blisters, 5: dense/big blisters
**Assessment of cross hatches according to DIN EN ISO 2409; 2 mm grid; pull off one time with Tesa 4657 tape; double determination; mean of two crosshatches documented.

Table 8 shows that the combined multilayer application process on metal substrates described above also leads to very good adhesion performance. The inventive process therefore combines significantly reduced application time with very good quality results also if metal substrates are coated.

### Example 6: Application of the Ready for Use Compositions of IE 1, IE 2 and CE 3 in Combination with a Solvent Borne Basecoat

The surfacer coating compositions of IE 1, IE 2 and CE 3 as described above were applied on a further set of E-coated steel panels and overcoated with commercially available refinish solventborne basecoat (Permacron® Base Coat 293/295/297 in RAL5010 color shade from Spies Hecker) and a refinish solventborne clearcoat (Permacron® MS VarioPlus Clear Coat 8050/SH3310 activator/SH3364 reducer from Spies Hecker) after 5 minutes flash off time at 22° C. and a relative humidity of 45%. Basecoat and clearcoat compositions were applied according to their technical datasheets. After clearcoat application the paint systems were baked for 30 minutes at 60° C. The appearance of the paint systems was measured 24 hours after clearcoat bake and storage of panels at ambient temperatures with a Byk Gardner Wave-Scan Dual (catalog number 4840).

TABLE 9
Results of the wet on wet application process with solventborne
basecoat and solventborne clearcoat on E-coated steel panels:

| | | | | | Market references | | | |
|---|---|---|---|---|---|---|---|---|
| | Inventive examples | | | | CE | CE | CE | CE |
| example | IE1.1 | IE1.2 | IE2.1 | IE2.2 | 3.1 | 3.2 | 3.3 | 3.4 |
| coats | 1.5 | 1.5 | 1.5 | 1.5 | 1.5 | 1.5 | 1.5 | 1.5 |
| flash off time before base- | 5 | | | | | | | |
| coat application [min] | | | | | | | | |
| film thickness (μm) | 28 | 28 | 26 | 28 | 28 | 31 | 24 | 35 |
| Basecoat | Permacron ® Base Coat in RAL5010 | | | | | | | |
| | (TDS version EN/029XA.4) | | | | | | | |
| base coat film thickness | 13 | 14 | 12 | 12 | 12 | 14 | 13 | 12 |
| Clearcoat | Permacron ® MS VarioPlus Clear Coat 8050/SH3310/SH3364 | | | | | | | |
| | (TDS version EN/8050A.8) | | | | | | | |
| clear coat film thickness | 65 | 65 | 65 | 65 | 58 | 58 | 55 | 55 |

Appearance after 24 hours (wavescan)

| | | | | | | | | |
|---|---|---|---|---|---|---|---|---|
| DOI | 86 | 86 | 86 | 87 | 87 | 87 | 89 | 84 |
| dullness | 8 | 8 | 8 | 8 | 10 | 8 | 6 | 12 |
| Tension | 20 | 19 | 20 | 20 | 19 | 19 | 18 | 17 |
| Shortwave | 32 | 31 | 30 | 30 | 28 | 30 | 24 | 35 |
| Longwave | 5 | 6 | 4 | 4 | 5 | 5 | 8 | 10 |

Application of the ready for use compositions of IE 1, IE 2 and CE 3 in combination with a solvent borne top coat

The surfacer coating compositions of IE 1, IE 2 and CE 3 as described above were applied on a further set of E-coated steel panels and overcoated with commercially available refinish solventborne topcoat (Permasolid® HS Automotive Top Coat 275 in RAL 5010 from Spies Hecker) after 5 minutes flash off time at 22° C. and a relative humidity of 45% according to its technical datasheet. After topcoat application the paint systems were baked for 30 minutes at 60° C. The appearance of the paint systems was measured 24 hours after clearcoat bake and storage of panels at ambient temperatures with a Byk Gardner Wave-Scan Dual (catalog number 4840).

TABLE 10
Results of the wet on wet application process with
solventborne topcoat on E-coated steel panels

| | | | | | Market references | | | |
|---|---|---|---|---|---|---|---|---|
| | Inventive examples | | | | CE | CE | CE | CE |
| example | IE1.1 | IE1.2 | IE2.1 | IE2.2 | 3.1 | 3.2 | 3.3 | 3.4 |
| coats | 1.5 | 1.5 | 1.5 | 1.5 | 1.5 | 1.5 | 1.5 | 1.5 |
| flash off time before base- | 5 | | | | | | | |
| coat application [min] | | | | | | | | |
| film thickness (μm) | 28 | 28 | 26 | 28 | 28 | 31 | 24 | 35 |
| Topcoat | Permasolid ® HS Automotive Top Coat 275 in RAL 5010 | | | | | | | |
| | (TDS version EN/0275A.4) | | | | | | | |
| Topcoat film thickness | 59 | 55 | 65 | 58 | 58 | 57 | 53 | 53 |

Appearance after 24 hours (wavescan)

| | | | | | | | | |
|---|---|---|---|---|---|---|---|---|
| DOI | 96 | 92 | 95 | 94 | 92 | 94 | 95 | 90 |
| dullness | 1 | 4 | 2 | 3 | 5 | 2 | 2 | 7 |
| Tension | 24 | 22 | 24 | 24 | 23 | 24 | 23 | 20 |
| Shortwave | 8 | 19 | 9 | 11 | 14 | 10 | 9 | 21 |
| Longwave | 1 | 3 | 1 | 2 | 2 | 1 | 2 | 5 |

Table 9 and Table 10 show that the compositions of IE 1 and IE 2 have similar or even better topcoat appearance when they are overcoated with solventborne basecoat and clearcoat or solventborne topcoat. However, the compositions of IE 1 and IE 2 additionally have a better de-nibbing capability development as shown in Table 6 above.

1. Wet on wet process for multilayer coating of a substrate, the process comprising the steps of:
(i) applying on the substrate to be coated a surfacer layer of an organic solvent-based surfacer coating composition comprising:
A) at least one polyaspartic acid ester;
B) at least one polyisocyanate cross-linking agent with free isocyanate groups;
C) at least one pigment and/or extender; and
D) at least one organic solvent;
(ii) flashing off the surfacer layer; and
(iii) applying a top coat layer on the surfacer layer.

2. The wet on wet process of claim 1, wherein the surfacer coating composition further comprises E) at least one additional binder component.

3. The wet on wet process of claim 2, wherein the binder component is selected from the group consisting of hydroxy-functional binders, amino-functional binders, aminoalcohol-functional binders, aldimines and/or ketimines.

4. The wet on wet process of claim 1, wherein the surfacer coating composition comprises B) at least one aromatically bound polyisocyanate cross-linking agent with free isocyanate groups.

5. The wet on wet process according to claim 1, wherein flashing off the surfacer layer is performed for 15 minutes or less.

6. The wet on wet process according to claim 1, wherein the top coat layer comprises a base coat layer and a clear coat layer.

7. The wet on wet process according to claim 1, wherein the top coat layer is a pigmented single stage top coat layer.

8. The wet on wet process of claim 6, wherein the clear coat layer comprises at least one polyaspartic acid ester and at least one polyisocyanate cross-linking agent with free isocyanate groups.

9. The wet on wet process of claim 8, wherein the base coat layer comprises at least one polyisocyanate cross-linking agent with free isocyanate groups.

10. The wet on wet process of claim 6, wherein the base coat is a water-based base coat.

11. The wet on wet process according to claim 1, wherein the polyaspartic acid ester is a compound of Formula (I): 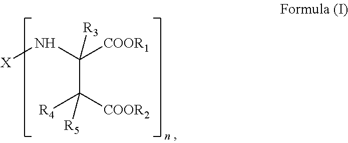
wherein X represents an n-valent organic group, obtained by removal of the amino groups from a primary polyamine or polyetheramine; R₁ and R₂ are the same or different organic groups which are inert towards isocyanate groups, R₃, R₄ and R₅ are the same or different and represent hydrogen or organic groups which are inert towards isocyanate groups, and n represents an integer with a value of at least 2, or
a chain-extended aspartate prepolymer which
(i) is free of isocyanate groups,
(ii) is a reaction product of
(ii-a) a mixture comprising at least one di-aspartic acid ester and at least one amino-functional mono-aspartic acid ester, wherein the molar ratio between the at least one di-aspartic acid ester and the at least one amino-functional mono-aspartic acid ester is from about 99.5:0.5 to about 50:50, and
(ii-b) at least one polyisocyanate.

12. The wet on wet process according to claim 1, wherein the organic solvent-based surfacer coating composition is applied using at least one of a manual pressure feed spray gun, a suction feed spray gun, airless and airmix techniques, pressure pot techniques and non-manual automated techniques.

13. The wet on wet process according to claim 1, wherein the substrate is a metal substrate.

14. The wet on wet process according to claim 13, wherein the metal substrate comprises vehicle bodies or vehicle body parts.

15. The wet on wet process according to claim 13, further comprising a step of pretreating the substrate to be coated with an acidic aqueous composition comprising at least one of phosphate ions, a water-soluble titanium compound and a water-soluble zirconium compound and water.

16. The wet on wet process according to claim 15, further comprising a step of subjecting the pre-treated substrate to a flash-off phase.

17. The wet on wet process of claim 15, wherein the acidic aqueous composition comprises about 1 to about 25% by weight, relative to the total amount of the acidic aqueous composition, of phosphate ions.

18. The wet on wet process of claim 15, wherein the acidic aqueous composition comprises about 0.3 to about 3% by weight, relative to the total amount of the acidic aqueous composition, of the water-soluble titanium compound and the water-soluble zirconium compound, calculated as elemental titanium and zirconium.

19. The wet on wet process according to claim 15, wherein the water-soluble titanium compound and the water-soluble zirconium compound is selected from a group consisting of titanium containing complex fluoro acids, zirconium containing complex fluoro acids, fluoro complexes of titanium, fluoro complexes of zirconium, and a combination thereof.

20. The wet on wet process according to claim 15, wherein the acidic aqueous composition is applied by wiping.
